(19) United States
(12) Patent Application Publication
(10) Pub. No.: US 2003/0088857 A1
(43) Pub. Date: May 8, 2003

(54) Method for facilitating application development

(76) Inventors: Alexander Balva, San Bruno, CA (US); Michael Gravel, Dallas, TX (US)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 10/198,530

(22) Filed: Jul. 17, 2002

Related U.S. Application Data
(60) Provisional application No. 60/337,037, filed on Nov. 6, 2001.

(51) Int. Cl. G06F 9/45; G06F 9/44

(52) U.S. Cl. 717/137; 717/120

(57) ABSTRACT

A method and device are provided to define functional structures for an application based on first input in a first language; to identify relationships between the functional structures; to organize the functional structures in a hierarchical framework based on the relationships; to change a functional structure based on second input, while limiting an effect of the change on other related functional structures in the hierarchical framework; and to transform the functional structures into code in a second language.

### CLAIM OF PRIORITY

This application is related to, and hereby claims the benefit of provisional application No. 60/337,037 which was filed Nov. 6, 2001.

### FIELD

This invention relates to the development of software applications.

### BACKGROUND

Scalability refers to the ability of a computer program or application to continue to function well, despite changes to meet user need. Such changes could include changes to the application itself, for example, a number of users that the application supports or changes to an environment in which the application runs. In order to gain wide spread acceptance in the marketplace there is a need for applications to be scalable.

To achieve scalability, parts of an application may have to be configured or modified to accommodate the changes based on user need. Configuring or modifying such parts of an application may affect other parts of the application resulting in the application as a whole not functioning properly. The risk of this occurring is great in applications containing a significant amount of code where it is not easy to appreciate how changing one part of the application affects other parts.

There is thus a need to be able to configure or modify an application in order to achieve scalability in a manner that minimizes the introduction of errors into the application.

Another problem faced by modern software developers is that of runtime functional redundancy. This occurs where a package or program suite has many components, not all of which are required by individual programs in the suite, but which nevertheless gets loaded into memory at runtime, thereby consuming valuable memory even though these components are not required by a particular program in the suite in current use. Runtime functional redundancy is an artifact of object-oriented design which does not allow partial or selective inheritance of objects by a program within a program suite.

There is thus a need for an application design methodology that facilitates partial inheritance of software components thereby avoiding runtime functional redundancy.

### SUMMARY

According to a first aspect of the invention there is provided a method for facilitating application development, the method comprising defining functional structures for an application based on first input in a first language; identifying relationships between the functional structures; organizing the functional structures in a hierarchical framework based on the relationships; changing a functional structure based on second input, while limiting an effect of the change on other related functional structures in the hierarchical framework; and transforming the functional structures into code in a second language.

According to a second aspect of the invention there is provided a method for facilitating application development, the method comprising receiving input defining functional modules for an application; constructing a tree data structure for the application based on the input, wherein each functional module defines a node in the tree data structure and a configuration of the tree data structure represents parent-child relationships between the functional modules; receiving input to change a parameter of a functional module; analyzing an effect of the change on other functional modules in the tree data structure; and reporting the effect of the change.

According to a third aspect of the invention there is provided a method for facilitating application development, the method comprising receiving first input defining functional modules for an application; constructing a tree data structure for the application based on the first input, wherein each functional module defines a node in the tree data structure and a configuration of the tree data structure represents parent-child relationships between the functional modules; receiving second input to change a functional module; and changing the functional module based on the second input while limiting the effect of the change on other modules based on a change control parameter.

Other features and advantages of the present invention will be apparent from the accompanying drawings, and from the detailed description, that follows below.

### BRIEF DESCRIPTION OF THE DRAWINGS

Embodiments of the present invention are illustrated by way of example, and not limitation, by the figures of the accompanying drawings in which like references indicate similar elements and in which:

FIG. 1 shows a configuration tree in accordance with one aspect of the invention;

FIGS. 2 through 4 show operations performed in accordance with different aspects of the invention; and

FIG. 5 shows a block diagram of a system in accordance with one aspect of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one case” or “a case” means that a particular feature, structure, or characteristic described in connection with the case is included in at least one case of the invention. The appearances of the phrase “in one case” in various places in the specification are not necessarily all referring to the same case, nor are separate or alternative cases mutually exclusive of other cases. Moreover, various features are described which may be exhibited by some cases and not by others. Similarly, various requirements are described which may be requirements for some cases but not other cases. Aspects of the present invention disclose a method and a system that excludes the non-required functionality from runtime components, as well allowing on the design side, partial inheritance to support sustainable configuration management for large scale applications.

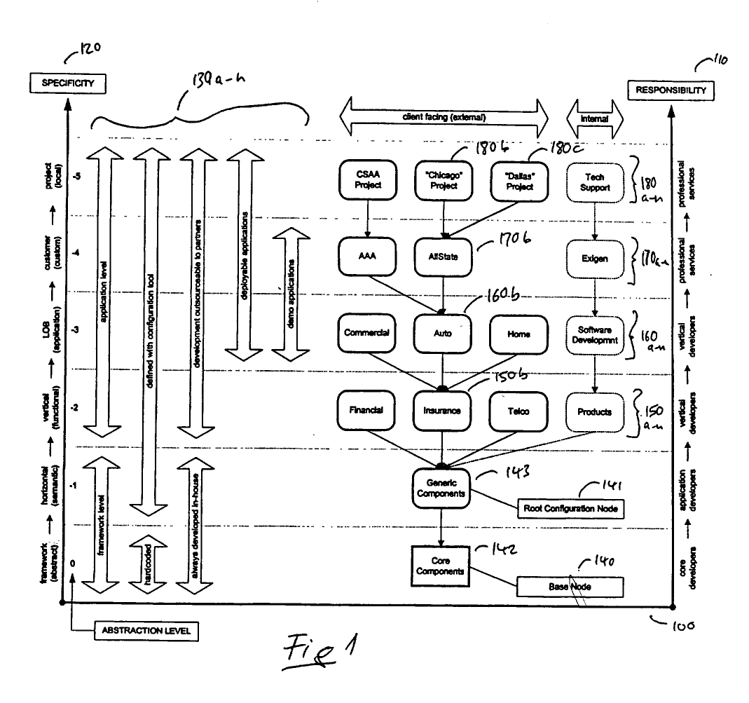

In particular the present invention discloses a method for facilitating application development, which in one case, produces a configuration tree such as the one shown in FIG. 1 of the drawings, which shows a configuration tree for a software suite for, e.g. insurance companies. At the bottom is the baseline 100. On right side is the responsibility axis 110, showing the set of people responsible for the implementation of the modules of each layer. On the left side is specificity axis 120, showing the specificity corresponding to the use of each layer. The specificity layers have a certain bandwidth of how to be implemented, as indicated by arrows 130 a-n, and the actual applications are split into two columns, internal and external, and are layered with layer numbers 140x on the root section, 150x, 160x, 170x, and 180x, respectively.

As shown in FIG. 1, an example that goes to the finest granularity would be in the auto insurance industry, for a company such as, for example, AllState™. Allstate has been chosen as a simple example; any other insurance company could be used. Examples of state-specific, localized applications for AllState are blocks 180b (the Chicago project) and 180c (the Dallas project).

At the very bottom of the configuration tree is the base node 142, which has anchored to it the root configuration node 143 (Items 141&142 are explanatory text boxes for the item 142&143 resp.). The root configuration node 143 is not really considered part of the tree, but are rather a special anchor.

It is entirely within the scope of the novel art of this disclosure that there may be more than one version of the configuration tree, which could be anchored with different base nodes and different root configuration nodes.

Each node has an interface to the node below it and one to the node above it. These nodes can communicate in the manner of atomic items, such as objects, applications, pages, data models, and work flow. The word “interface” is used here in this context in a very broad sense. The nodes are actually the collections of declarations (configuration) and have no interfaces in the traditional software industry meaning of this word. The applications produced off nodes of the tree are completely independent and execute the logic of the abstraction level for which they have been produced. The child/parent relation of the configuration nodes does not get transitioned into run-time in any way.

The nodes do not actually contain the application itself, but rather a set of parameters that describe features of the software (i. e. a source code expressed in a declarative as opposed to procedural language), and is used to generate the applications. This declarative language is used to enables the partial inheritance, and ultimately the entire presented methodology.

Applications can include a set of functional units with navigation or any other kind of elements that are necessary to create and/or operate an application. In this example, node 150b would be the generic node for the insurance industry, node 160b would be the subset relating to all various types of insurance, and node 170b would be the subnode relating to Allstate Insurance.

Nodes 180b and 180c are examples of localized versions, for example, node 180b for Chicago (following Illinois law) and node 180c for Dallas (following Texas law).

The configuration of a given abstraction level depends only on the configuration of the parent of the abstraction level. That means that if a function is made available, for example, in node 150b, then node 160 a-n (or in this example, 160 a-c) can draw on it; whereas a change in node 150b would not affect nodes 150a, 150c, or any of the previous levels of base node 140c, as well as the d column of 150d through 180d.

Conversely, an added feature of 160 may not require changes in 150 as long as it stays within the definition passed through, and does not require the children of 160b to be changed unless they need this additional datum or functional feature. As a result, changes can be made very localized in one element of the configuration tree, without having to update all the pieces along the tree.

In particular, the approach described with localization allows for a controlled propagation of changes down the configuration tree (the change does not get inherited unless specifically requested). That reduces the amount of (or eliminates) changes required in modules not really affected by a requirement.

Further, in some cases, the use of the controlled propagation of changes allows for addition and or removal of both configuration tree levels as well as promoting and or demoting (moving up/down the tree) of configuration items (modules) without inflicting cascading changes in all dependent configurations.

One of the main aspects, is an special option of the inheritance of features from nodes to their children. Rather than pass through every change as is, for example, when an element is added in a node (e.g. the middle name of a person), that is negated in the children and thus does not propagate to all the descendants down the tree (or up in FIG. 1). Only if an application needs it, than that automatic negation is eliminated, thus allowing it to further propagate. Thus an “automatic avalanche” of regeneration is avoided, allowing for more stable persistence of children or further remote descendants. In this example, the children do not need to handle the middle name, so their code does not have to be regenerated accordingly. In some cases, it may be selectively passed down only one path to the last descendents, but not to “sisters or cousins.”

There are specific details as an example in Appendix A, which is incorporated herein by reference.

Yet another application in addition to the so-called enterprise applications such as services industries (insurance companies, banks, brokerages, government etc.) and the industrial sector with its ERP (enterprise resource planning) and MRP (material resource planning) for manufacturing companies (both “old industries” and hi-tech), may be in software design and creation. For example, an application suite for office use, e.g., equivalent to Microsoft Office™ may be created using the novel art of this disclosure. This approach would have for each application a tree (as in FIG. 1) of its own (e.g., Word™, Excel™, Outlook™, etc.), and the branches at the very top level could represent localized versions for different countries. Such an approach could dramatically reduce the size of the application, improve turnaround time for special features, and maintain interoperability throughout the system, even if massive changes are done in one module, without requiring redundant code for the changed and unchanged modules.

According to one aspect of the invention, to facilitate the unified referencing of the nodes in a configuration tree the following schema may be used.

The base node will be referenced to as N₀. Assuming a single configuration tree instance, the root node will be referenced to as N₁. In general, there might be more than one instance of the configuration tree, residing in a configuration store. In this case, the root node of a specific configuration tree will be referenced to as Nₐ, where a is a positive integer. A direct child node of the root node will be referenced to as N_{a,b}. Then, the child node of N_{a,b} will be referenced to as N_{a,b,c} and so on.

Assuming that \overline{v} is the vector that defines the dimensions of a configuration node such as \overline{v}=\overline{(a,b,c, . . . ,x)}, this node can also be referenced to as N_{\overline{v}}.

The parent node of N_{\overline{v}} will be referenced to as P(N_{\overline{v}}). Thus, P(Nₐ)=N₀ and P(N_{a,b,c})=N_{a,b}. The set of child nodes of N_{\overline{v}} will be referenced to as {overscore (C(N_{v)}}). Since a node might have multiple children, {overscore (C(N_{v)}}) is defined as vector. Child n of node N_{\overline{v}} will be defined as Cₙ(N_{\overline{v}}). Thus, Cₐ(N₀)=Nₐ and C_{c} (N_{a,b})=N_{a,b,c}.

Each configuration node, including the base node, is related to certain abstraction level of a configuration tree. The abstraction level of a node is expressed as the negative length of the path from the node to the base node of the full configuration tree. Thus, for the base node N₀ the abstraction level A(N₀)=0. For the root node Nₐ the abstraction level A(Nₐ)=−1. For non-base node N_{\overline{v}}, the abstraction level A(N_{\overline{v}})=−length(\overline{v}). Negative numbers are used to indicate that the level of abstraction decreases as one moves from more generic applications (close to the root node) to more specific applications (further away from the root node).

The following are the valid equations derived from the definitions above:

A(P(N_{\overline{v}}))=A(N_{\overline{v}})+1

A(Cₙ(N_{\overline{v}}))=A(N_{\overline{v}})−1

Each application is declared as a configuration item of a type application. Each application is fully defined in the configuration contained within a node. Applications have the same abstraction level as their containing node.

The following basic operations are defined for the configuration information: Addition (+); Subtraction (−); Comparison (=,≠); and Transformation (→).

The addition (+) operation facilitates traditional inheritance. The subtraction operation (−) facilitates partial inheritance. The comparison operation (=, ≠) allows comparison between nodes for configuration validation purposes. The transformation (→) operation enables the production of an application off a defined configuration.

The configuration information stored in a node serves one of the two purposes. Firstly, the information defines a configuration difference between the current node from its parent node. Secondly, the information defines a target configuration produced by current node.

The first use is referred to as a delta configuration and is referred to as Δ(N_{\overline{v}}) or Δ_{\overline{v}}; the second use is referred to as a target configuration and is referred to as Σ(N_{\overline{v}}) or Σ_{\overline{v}}. The delta configuration Δ(N_{\overline{v}}) pertaining to N_{\overline{v}} defines the difference that needs to be applied to target configuration pertaining to in order to produce the target configuration Σ(N_{\overline{v}}). That is,

Σ(N_{\overline{v}})=Σ(P(N_{\overline{v}}))+Δ(N_{\overline{v}}).

Application developers may modify a delta configuration in order to produce an application. A target configuration is calculated based on a delta configurations and, thus, are not directly editable. For instance, the target configuration for a node with level of abstraction −3 can be calculated as

Σ_{a,b,c}=Δ_{a,b,c}+Σ_{a,b}=Δ_{a,b,c}+Δ_{a,b}+Σₐ=Δ_{a,b,c}+Δ_{a,b}+Δₐ+Σ₀.

A delta configuration for the read-only base node is not defined. The base node would only posses a target configuration.

The configuration of a given abstraction level depends only on the configuration of its parent abstraction level. Change introduced on a given abstraction level affects only configuration of that abstraction level. Introduction of a new abstraction level does not compromise the run-time performance of the resulting applications.

Part of a configuration may be detached for independent maintenance. For example, sub-trees of a configuration tree may be detached to produce independent configuration trees. The parent node of the detached node is the base node for the detached sub-tree. The base node will be included in the detached configuration as a read-only object. Unlike the root node of a full configuration tree, the root node of sub-tree will have the abstraction level different from zero. Detached configuration trees may be modified.

Detached configuration trees may be re-attached to a full configuration tree. When re-attaching the detached configuration overwrites part of the full-tree configuration. The base node, however will not be merged, but, instead, will be used to determine if changes have been made to the full-tree configuration after detachment and to prompt appropriate correction to the detached configuration before the re-attachment operation can be completed.

Detaching and reattaching sub trees is specifically useful when outsourcing development.

A configuration tree is design-time verifiable and may be version-controlled. Operations on a configuration tree include creation of a new node. A new node is created with empty configuration information. Empty configuration information means no difference from the parent node (everything gets inherited). Thus, applications generated off a new node and its parent node will be identical. Further, a node may be cloned i.e. a new node is created with configuration information of given peer node. Deletion of a node involves removal of a node. When deleting a node, child sub-hierarchies of the node gets removed or promoted one level; i.e. (become the sub-hierarchies of the parent node of the removed node). Promotion of a configuration item involves a deletion of the item on level n and recreation it on the level n+1. Demotion of a configuration item involves a deletion of the Item on level n and recreation it on the level n−1. Addition of configuration item comprises defining a new item in a given node.

Deletion of a configuration item involves removing a previously defined configuration from a given node. Masking of a configuration item involves masking the configuration such that child node sees the masked item. However, the current node sees it. This function facilitates selective inheritance. Exclusion of a configuration item includes the configuration item such that neither the current node, nor its children can see the item. This function facilitates selective inheritance.

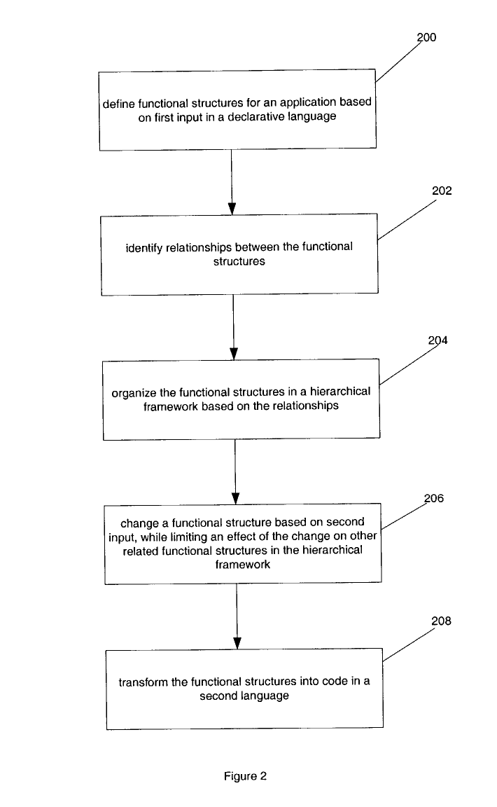

Having described configuration trees and how they may be used to facilitate application program development, FIG. 2 of the drawings shows a flow chart of operations performed by an application development tool in accordance with one aspect of the invention. Referring to FIG. 2, at block 200, the application development tool defines functional structures for an application based on first input in a declarative language. One example of a declarative language that may be used includes Extensible Mark-up Language (XML). In one case, the functional structures comprise the configuration items in a configuration tree.

At block 204 the application development tool identifies relationships between the functional structures. In one case these functional relationships may include parent-child relationships. At block 206 the application development tool organizes the functional structures in a hierarchical framework based on the relationships. In one case, the hierarchical framework may comprise a configuration tree as described above.

At block 206, the application development tool changes a functional structure based on second input, while limiting an effect of the change and other related structures in the hierarchical framework. For example, an application developer may decide to change a particular functional structure but may not wish the change to affect other dependent functional structures. Accordingly, the application development tool allows the developer to set a limit on a number of generations of nodes for the functional structures that may be affected by the change. Thus, the effect of the change may be highly localized so that other functional structures remain unaffected.

At block 210 the application development tool transforms the functional structure into code in a second language. Examples of the second language include C++, and Java.

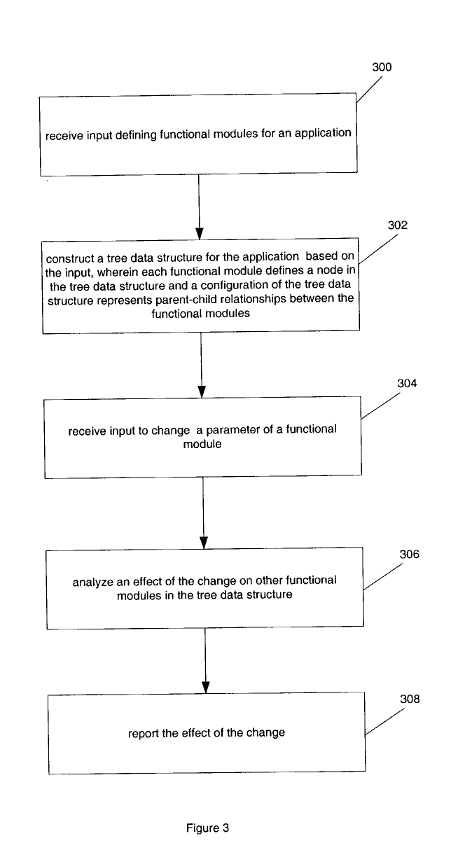

FIG. 3 of the drawings shows a flow chart of operations performed by a software development tool in accordance with another aspect of the invention. Referring to FIG. 3, at block 300 the software development tool receives input defining functional modules for an application. Typically the input is in a declarative language such as XML.

At block 302 the application development tool constructs a tree data structure, for example a configuration tree as described above, for the application based on the input.

Within the tree data structure, each functional module defines a node in the tree data structure and a configuration of the tree data structure represents parent-child relationships between the functional modules.

At block 304 the application development tool receives input to change a parameter of a functional module. At block 306 the application development tool analyzes an effect of the change and other functional modules in the tree data structure. At block 308 the application development tool reports the effect of the change to the application developer. This allows the application developer to see the full effect of the proposed change to other functional modules in the tree data structure. Based on this, the application developer may decide to go ahead with the proposed change or the application developer may decide not to proceed with the proposed change.

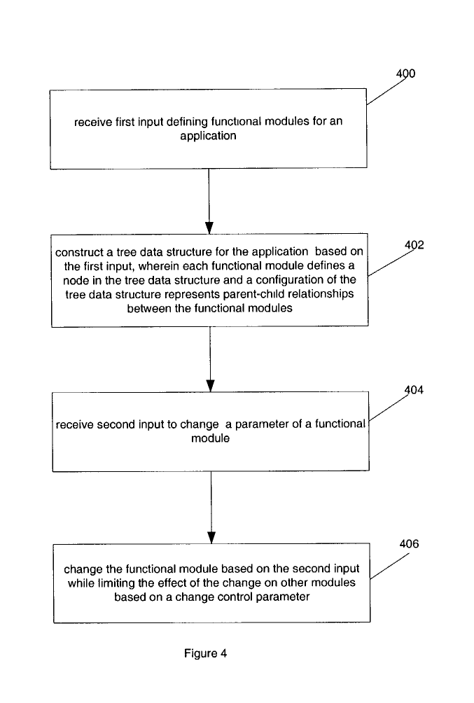

Referring now to FIG. 4 of the drawings, a sequence of operations performed by an application development tool in accordance with another case is shown.

At 400 the application development tool receives first input defining functional modules for application. At block 402 the application development tool constructs a tree data structure for the application (e.g. a configuration tree) based on the first input.

Each functional module defines a node in the tree data structure and a configuration of the tree data structure represents parent-child relationships between the functional modules. At block 404 the application development tool receives second input to change a parameter of a functional module. Typically the first and second inputs are in a declarative programming language such as XML.

At block 406 the application development tool changes the functional module based on the second input while limiting the effect of the change on other modules based on a change control parameter.

The change control parameter, in one case, controls a maximum number of generations of child nodes for the functional module that may be affected by the change.

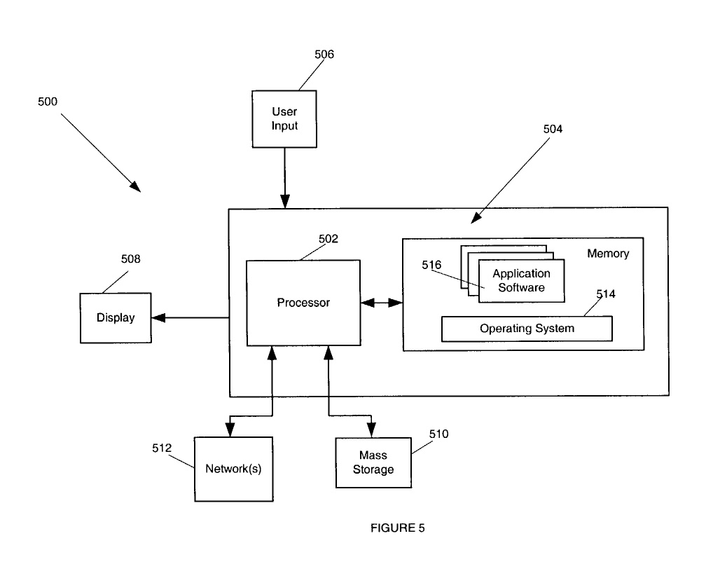

FIG. 5 of the drawings shows an example of a processing system 500 in accordance with one aspect of the invention.

Processing system 500 typically includes at least one processor 502 coupled to a memory 504. Processor 502 may represent one or more processors (e.g. microprocessors), and memory 504 may represent random access memory (RAM) devices comprising a main storage of system 500, as well as any supplemental levels of memory e.g., cache memories, non-volatile or back-up memories (e.g. programmable or flash memories), read-only memories, etc. In addition, memory 504 may be considered to include memory storage physically located elsewhere in system 500, e.g. any cache memory in a processor 502, as well as any storage capacity used as a virtual memory, e.g., as stored on a mass storage device 510 or on another computer coupled to system 500 via network 512.

Processing system 500 also typically receives a number of inputs and outputs for communicating information externally. For interface with a user or operator, system 500 typically includes one or more user input devices 506 (e.g., a keyboard, a mouse, etc.) and a display 508 (e.g., a CRT monitor, a LCD panel). However, with some implementations of system 500, such as in a server, direct local) user input and output may not be required, such that user input devices 506 and display 508 may be omitted.

For additional storage, system 500 may also include one or more mass storage devices 510, e.g., a floppy or other removable disk drive, a hard disk drive, a Direct Access Storage Device (DASD), an optical drive (e.g. a CD drive, a DVD drive, etc.) and/or a tape drive, among others. Furthermore, hardware 500 may include an interface with one or more networks 512 (e.g., a land, a WAN, a wireless network, and/or the Internet among others) to permit the communication of information with other computers coupled to the networks. It should be appreciated that system 500 typically includes suitable analog and/or digital interfaces between processor 502 and each of the components 504, 506, 508 and 512 as is well known in the art.

Processing system 500 operates under the control of an operating system 514, and executes various computer software applications, components, programs, objects, modules, etc. (e.g. a program or module which performs operations as shown in FIGS. 2, 3 and 4 of the drawings). Moreover, various applications, components, programs, objects, etc. may also execute on one or more processors in another computer coupled to system 500 via a network 512, e.g. in a distributed computing environment, whereby the processing required to implement the functions of a computer program may be allocated to multiple computers over a network.

It is clear to a person skilled in the art that this new method and system can be implemented in many ways, without departing from the spirit of the invention.

In the following detailed description of exemplary embodiments of the present invention, numerous specific details are set forth in order to provide a thorough understanding of the described embodiments of the present invention. However, it will be apparent to one skilled in the art that alternative embodiments of the present invention may be practiced without these specific details. In some instances, well-known structures and devices are shown in block diagram form, rather than in detail, in order to avoid obscuring the description of exemplary embodiments of the present invention.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method for facilitating application development, the method comprising:
defining functional structures for an application based on first input in a first language;
identifying relationships between the functional structures;
organizing the functional structures in a hierarchical framework based on the relationships;
changing a functional structure based on second input, while limiting an effect of the change on other related functional structures in the hierarchical framework; and
transforming the functional structures into code in a second language.

2. The method of claim 1, wherein the first language is a declarative language and the second language is a procedural language.

3. The method of claim 2, wherein the hierarchical framework comprises a tree data structure wherein each functional structure is represented as a node in the tree data structure.

4. The method of claim 3, wherein the identified relationships comprise parent and child relationships between the nodes for the functional structures.

5. The method of claim 4, wherein limiting the effect of the change comprises setting a limit on a number of generations of nodes for the functional structures that may be affected by the change.

6. The method of claim 5, further comprising receiving input specifying a proposed change to a functional structure; analyzing an effect of the proposed change on other functional units; and reporting the effect.

7. A method for facilitating application development, the method comprising:
receiving input defining functional modules for an application;
constructing a tree data structure for the application based on the input, wherein each functional module defines a node in the tree data structure and a configuration of the tree data structure represents parent-child relationships between the functional modules;
receiving input to change a parameter of a functional module;
analyzing an effect of the change on other functional modules in the tree data structure; and
reporting the effect of the change.

8. The method of claim 7, further comprising changing the parameter if the reported effect is accepted by an operator.

9. The method of claim 8, wherein the input defining the functional modules is in a declarative language.

10. The method of claim 9, further comprising transforming each functional module into code in a procedural language based on operator input.

11. A method for facilitating application development, the method comprising;
receiving first input defining functional modules for an application;
constructing a tree data structure for the application based on the first input, wherein each functional module defines a node in the tree data structure and a configuration of the tree data structure represents parent-child relationships between the functional modules;
receiving second input to change a functional module; and
changing the functional module based on the second input while limiting the effect of the change on other modules based on a change control parameter.

12. The method of claim 11, wherein the change control parameter controls a maximum number of generations of child nodes for the functional module that may be affected by the change.

13. The method of claim 12, wherein the first input is in a declarative language.

14. The method of claim 13, further comprising transforming the functional modules into code in a procedural language.

15. A computer-readable medium having stored thereon a sequence which when executed by a computer, cause the computer to perform a method comprising:
defining functional structures for an application based on input in a first language;
identifying relationships between the functional structures;
organizing the functional structures in a hierarchical framework based on the relationships;
changing a functional structure based on second input, while limiting an effect of the change on other related functional structures in the hierarchical framework; and
transforming the functional structures into code in a second language

16. The computer-readable medium of claim 15, wherein the first language is a declarative language and the second language is a procedural language.

17. A computer-readable medium having stored thereon a sequence of instructions which when executed by a computer cause the computer to perform a method comprising:
receiving input defining functional modules for an application;
constructing a tree data structure for the application based on the input, wherein each functional module defines a node in the tree data structure and a configuration of the tree data structure represents parent-child relationships between the functional modules;
receiving input to change a parameter of a functional module;
analyzing an effect of the change on other functional modules in the tree data structure; and
reporting the effect of the change.

18. The computer-readable medium of claim 17, wherein the method further comprises changing the parameter if the reported effect is accepted by an operator.

19. A computer-readable medium having stored thereon a sequence of instructions which when executed by a computer cause the computer to perform a method comprising:
receiving first input defining functional module for an application;
constructing a tree data structure for the application based on the first input, wherein each functional module defines a node in the tree data structure and a configuration of the tree data structure represents parent-child relationships between the functional modules;
receiving second input to change a functional module; and
changing the functional module based on the second input while limiting the effect of the change on other modules based on a change control parameter.

20. The computer-readable medium of claim 19, wherein the change control parameter controls a maximum number of generations of child nodes for the functional module that may be affected by the change.
